(19) United States
(12) Patent Application Publication
(10) Pub. No.: US 2026/0228907 A1
(43) Pub. Date: Aug. 6, 2026

(54) SHAPE GENERATION APPARATUS, CONTROL METHOD, AND COMPUTER-READABLE STORAGE MEDIUM

(71) Applicant: CANON KABUSHIKI KAISHA, Tokyo (JP)

(72) Inventor: Yasufumi TAKAMA, Kanagawa (JP)

(21) Appl. No.: 19/463,354

(22) Filed: Jan. 29, 2026

(30) Foreign Application Priority Data
Feb. 6, 2025 (JP) 2025-018549

(51) Int. Cl. G06T 7/55; G06T 7/11; G06T 15/20

(52) U.S. Cl. CPC G06T 7/55; G06T 7/11; G06T 15/20

(57) ABSTRACT

A shape generation apparatus generates visible camera information indicating whether each of partial regions is visible from each of a plurality of cameras, the partial regions being obtained by dividing a shape generation region for which a shape model is to be generated, defines voxels in the shape generation region, determines whether each of the voxels is a portion of the subject by projecting the voxel onto a camera for which the partial region corresponding to the voxel is visible according to the visible camera information, and determines a size of a partial region based on a size of the shape generation region, a memory amount indicating an amount of memory available for holding the visible camera information, and information relating to a data size of data indicating whether one voxel is visible from each of the plurality of cameras.

### BACKGROUND

### Field of the Technology

The present disclosure relates to technology for generating a three-dimensional shape of a subject.

### Description of the Related Art

Technology is known that can generate a three-dimensional shape model of a subject from multiple viewpoint images obtained by capturing images of the subject from different directions using a plurality of image capturing apparatuses, and can generate an image (virtual viewpoint image) for when a virtual space in which the shape model is disposed is observed from any virtual viewpoint. The three-dimensional shape model of the subject is generated using a three-dimensional shape reconstruction method such as a visual hull method, for example. In the visual hull method, a shape model is represented by a collection of cubes (voxels).

A known method for capturing images of a subject existing in a wide space via a plurality of cameras and generating a shape model using the visual hull method at high-speeds includes a method that uses octree processing and visible camera information. Octree processing is processing that is repeated in stages starting with processing from coarse voxels and then finely dividing voxels in only the region in which the subject exists. The visible camera information is information relating to partial regions obtained by dividing the space and indicating which camera field of view each region is in. When determining whether each voxel corresponds to the subject in the visual hull method, this information is used to restrict the cameras used in the determination, thus allowing the amount of calculations required for generating the shape model to be reduced.

Japanese Patent Laid-Open No. 2021-033682 describes a method of ending octree processing by the visual hull method in response to the amount of memory used becoming excessive as a result of repeatedly dividing voxels. However, there is room for innovation in terms of appropriately handling the visible camera information.

### SUMMARY

According to one aspect of the present disclosure, there is provided a shape generation apparatus that generates a shape model of a subject using captured images captured using a plurality of cameras, comprising: one or more processors; and one or more memories that store a computer-readable instruction for causing, when executed by the one or more processors, the one or more processors to perform a control method comprising: generating visible camera information indicating whether or not each of partial regions is visible from each of the plurality of cameras, the partial regions being obtained by dividing a shape generation region for which the shape model is to be generated; defining a plurality of voxels in the shape generation region; determining whether each voxel included in the plurality of voxels is a portion of the subject by not projecting the voxel onto a camera for which the partial region corresponding to the voxel is not visible according to the visible camera information and projecting the voxel onto a camera for which the partial region corresponding to the voxel is visible according to the visible camera information; outputting the shape model of the subject based on a result of the determining; and determining a size of a partial region based on a size of the shape generation region, a memory amount indicating an amount of memory available for holding the visible camera information, and information relating to a data size of data indicating whether one voxel is visible from each of the plurality of cameras.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating a system configuration example.

FIG. 2A is a diagram for describing a coordinate system relating to camera parameters.

FIG. 2B is a diagram for describing a coordinate system relating to camera parameters.

FIG. 3 is a diagram illustrating a hardware configuration example of a shape generation apparatus.

FIG. 4A is a diagram for describing a shape generation region and a partial region.

FIG. 4B is a diagram for describing a shape generation region and a partial region.

FIG. 5A is a diagram for describing a number of divisions and hierarchies of an octree.

FIG. 5B is a diagram for describing a number of divisions and hierarchies of an octree.

FIG. 6 is a diagram illustrating an example of the flow of processing executed by shape generation processing.

FIG. 7 is a diagram illustrating an example of the flow of processing to calculate a partial region size.

FIG. 8 is a diagram illustrating an example of the flow of processing to generate visible camera information.

FIG. 9 is a diagram for describing division processing using an octree.

FIG. 10 is a diagram illustrating an example of a first voxel set for a hierarchy 0.

FIG. 11A is a diagram for describing a method of defining eight voxels from one voxel.

FIG. 11B is a diagram for describing a method of defining eight voxels from one voxel.

FIG. 11C is a diagram for describing a method of defining eight voxels from one voxel.

FIG. 12 is a diagram for describing a method of defining eight voxels from one voxel.

FIG. 13 is a diagram for describing a correspondence relationship between hierarchies of an octree and visible camera information.

FIG. 14A is a diagram for describing a correspondence relationship between voxels and visible camera information.

FIG. 14B is a diagram for describing a correspondence relationship between voxels and visible camera information.

FIG. 14C is a diagram for describing a correspondence relationship between voxels and visible camera information.

FIG. 15 is a diagram illustrating another example of a system configuration.

FIG. 16 is a diagram illustrating another example of the flow of processing executed by shape generation processing.

FIG. 17A is a diagram for describing a method of providing voxel coordinates and voxel IDs.

FIG. 17B is a diagram for describing a method of providing voxel coordinates and voxel IDs.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the following embodiments, an image processing system for forming a three-dimensional model (also referred to as a shape model, a 3D model, and the like) of a subject using the visual hull method is used, and an aim is to reduce the amount of processing that utilizes octree processing and visible camera information. By using visible camera information, the number of cameras that are taken into account when determining whether or not each of the voxels forms a portion of the subject can be reduced. Here, by preparing visible camera information appropriate for each of the voxels obtained in all of the stages of the octree processing, the octree processing can be efficiently executed. However, preparing such visible camera information requires a memory with a large capacity for holding this information. Also, if the imaging region is expanded, the amount of memory required to hold the visible camera information including information for each of the large number of partial regions existing in the expanded region is increased. Also, if the partial regions are made smaller, even in a small space, the amount of memory required to hold the visible camera information is increased. In other words, depending on the number of partial regions, the amount of memory required to hold the visible camera information may be huge. Thus, in the following embodiments, a technology is provided that enables visible camera information to be generated for partial regions of an appropriate fineness/coarseness taking into account the usable amount of memory. Also, there is a possibility that visible camera information is generated for a partial region of a size that is not suited to the size of the voxels. Thus, in the following embodiments, technology is further provided for using the generated visible camera information at an appropriate timing at the time of generation of a shape model via the visual hull method.

### First Embodiment

In the present embodiment, the example described is of a case where the visible camera information is generated at the time of activation of the apparatus. Also described is a method for appropriately using the visible camera information in accordance with the size of the voxels when a shape model of a subject is generated while changing the voxel size from a coarse size to a fine size.

### System and Apparatus Configuration

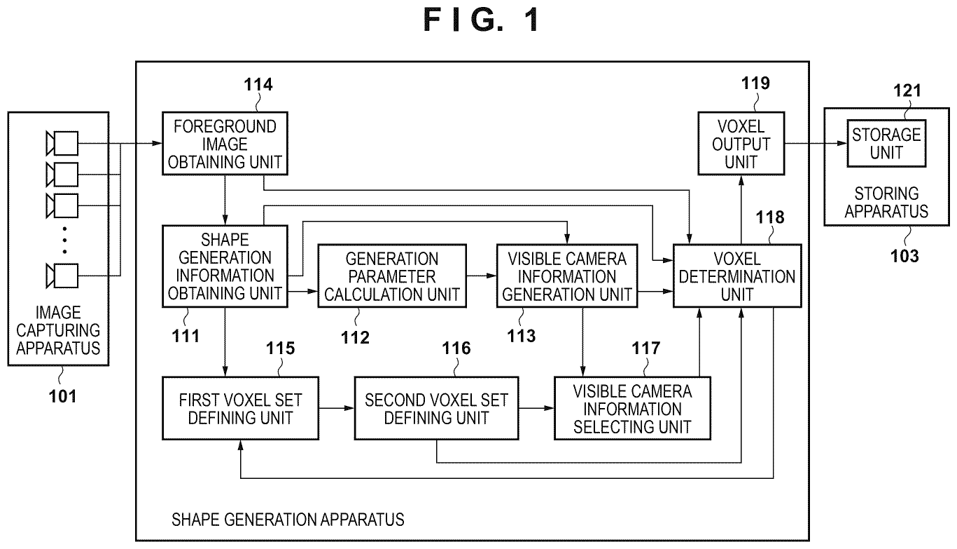

FIG. 1 illustrates a configuration example of an image processing system according to the present embodiment. The present image processing system includes, for example, an image capturing apparatus 101, a shape generation apparatus 102, and a storing apparatus 103. Note that this is an example, and the image processing system may have a different configuration. For example, an image generation apparatus that generates a virtual viewpoint image from a shape model of a subject generated by the shape generation apparatus 102 may be included. Also, for example, a plurality of apparatuses may be configured as a single apparatus, such as the storing apparatus 103 being included in the shape generation apparatus 102. For example, in one image capturing apparatus 101, the shape generation apparatus 102 may be included, and it may be configured so that captured images are collected from other image capturing apparatuses 101 to the shape generation apparatus 102. Note that the term “image” used in the present embodiment may be a still image or a moving image (video).

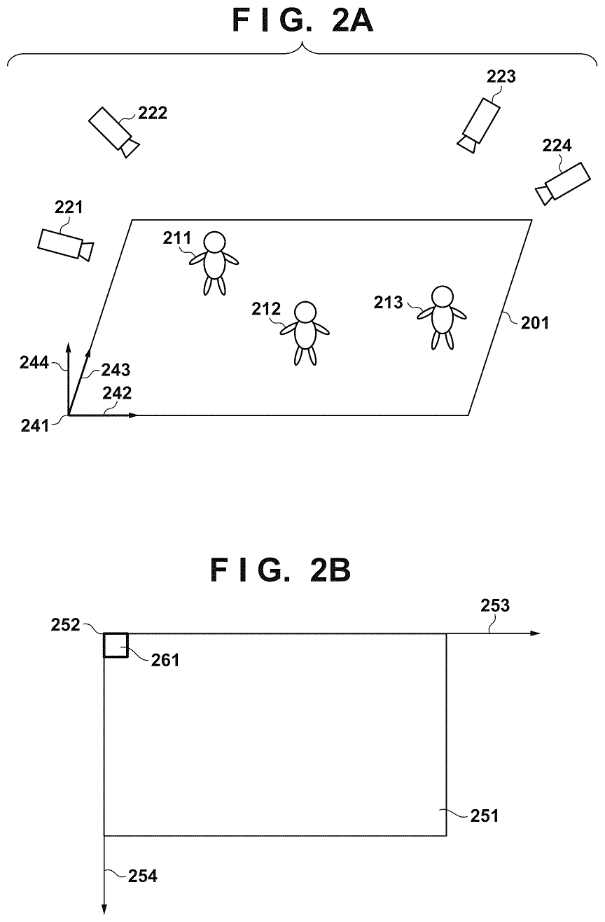

The image capturing apparatus 101 includes a plurality of cameras and executes image capture of a subject using the plurality of cameras. The plurality of cameras, for example, are placed in such a manner so as to capture images of subjects 211 to 213 on a field 201 from different directions as seen with cameras 221 to 224 illustrated in FIG. 2A. Hereinafter, the cameras 221 to 224 are simply referred to as “cameras” when there is no particular need to differentiate between them. The cameras include an identification number for identifying themselves. Note that the plurality of cameras may be placed around the entire periphery of the subject, or the cameras may be placed only in a predetermined angle range as seen from the subject depending on limitations on the placement location and the like. Also, the number of cameras is not limited, and in the case of capturing images of a soccer or rugby match, for example, tens to hundreds of cameras may be placed surrounding the field. Also, the plurality of cameras that are placed may have different fields of view, such as telephoto cameras and wide-angle cameras. All of the cameras in the system are synchronized by being connected to one another or by being connected to a time server or an apparatus that provides a reference time for the system and using time information in common with the real world, for example. Also, image capture time information is provided to the images captured by all of the cameras in the system.

The shape generation apparatus 102 uses the captured images and the information of the plurality of cameras to generate a shape model of the subject and outputs the shape model to the storing apparatus 103. The information of the plurality of cameras includes state information relating to image capture such as the position, orientation (facing or image capture direction), focal length, optical center, distortion, f-number, depth of field, and the like of each camera. Hereinafter, the camera state information may be referred to as camera parameters; the camera parameters relating to the position and orientation (facing or image capture direction) of the camera may be referred to as extrinsic parameters; and the parameters relating to focal length, image center, and distortion may be referred to as intrinsic parameters. The coordinate system associated with the camera parameters will now be described. The position and orientation of the camera 221 to camera 224 as illustrated in FIG. 2A may be represented in one world coordinate system formed by a three-dimensional coordinates origin 241, an Xw-axis 242, a Yw-axis 243, and a Zw-axis 244. Also, in FIG. 2B, a camera image coordinate system (hereinafter referred to as an image coordinate system) for a captured image 251 from each of the cameras 221 to 224 is illustrated. The image coordinate system is set with a two-dimensional coordinates origin 252, an Xi-axis 253, and a Yi-axis 254, and in the example of FIG. 2B, the pixel at coordinates (0, 0) is a pixel 261. The storing apparatus 103 stores the data of the shape model generated by the shape generation apparatus 102. Also, the storing apparatus 103 may hold the image data captured by the image capturing apparatus 101, for example, and provide the image data to the shape generation apparatus 102 as necessary. Also, the storing apparatus 103 may be configured to store information other than the shape model that is required for generation of a virtual viewpoint image by an image generation apparatus (not illustrated) and supply this information to the image generation apparatus as necessary.

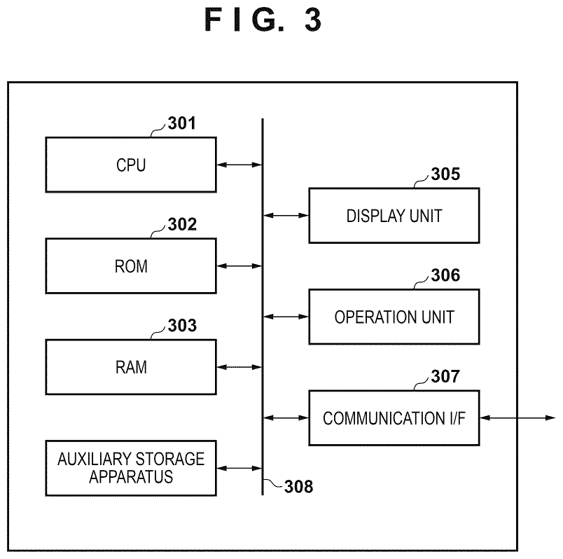

Next, a configuration example of the shape generation apparatus 102 will be described. FIG. 3 is a diagram illustrating a hardware configuration example of the shape generation apparatus 102. The shape generation apparatus 102, as hardware configuration, includes a CPU 301, a ROM 302, a RAM 303, an auxiliary storage apparatus 304, a display unit 305, an operation unit 306, a communication I/F 307, and a bus 308, for example. Herein, CPU is an abbreviation for central processing unit, ROM is an abbreviation for read only memory, RAM is an abbreviation for random access memory, and I/F is an abbreviation for interface.

The CPU 301 uses a computer program and data stored in at least one of the ROM 302, the RAM 303, and the auxiliary storage apparatus 304 to control the entire shape generation apparatus 102 and implement each function of the shape generation apparatus 102 described below. Note that the shape generation apparatus 102 may include one or more dedicated pieces of hardware other than the CPU 301 and may execute at least a portion of the processing by the CPU 301 via the dedicated hardware. The dedicated hardware may be, for example, an application specific integrated circuit (ASIC), a digital signal processor (DSP), a field-programmable gate array (FPGA), or the like. The CPU is an example, and the shape generation apparatus 102 may include one or more processors of any type such as a micro processing unit (MPU) or the like. Also, a plurality of processors such as a multi-core CPU may be used. The ROM 302 stores a program that does not require change. The RAM 303 temporarily stores programs and data supplied from the auxiliary storage apparatus 304, data supplied from outside via the communication I/F 307, and the like. Note that the ROM 302 and the RAM 303 are examples of memory, and the shape generation apparatus 102 may include one or more memories of any type. The auxiliary storage apparatus 304 includes a hard disk drive or the like, for example, and stores various types of data such as image data, audio data, and the like.

The display unit 305 includes an apparatus for presenting information such as a liquid crystal display, a light-emitting diode (LED), or the like, for example. The display unit 305 may display a graphical user interface (GUI) or the like for the user to operate the shape generation apparatus 102. Note that the display unit 305 may be configured to not only present visual information but may also present information via an audio output using a speaker or the like or a vibration output using a vibrator or the like, for example. The operation unit 306 includes hardware for receiving an operation from the user such as a keyboard and mouse, a joystick, a touch panel, and the like. The operation unit 306 receives a user operation via this configuration and supplies the CPU 301 with various types of instructions corresponding to the received operation. Note that the CPU 301 may function as a display control unit that controls the display unit 305 and an operation control unit that controls the operation unit 306. The communication I/F 307 includes hardware used in communicating with an apparatus external to the shape generation apparatus 102. For example, in a case where the shape generation apparatus 102 is connected to an external apparatus via a wired connection, a communication cable is connected to the communication I/F 307. In a case where the shape generation apparatus 102 has a function of wirelessly communicating with an external apparatus, the communication I/F 307 includes an antenna, a radio frequency (RF) chip, a baseband chip, and the like. The bus 308 is configured to connect the functional units of the shape generation apparatus 102 to one another and transfer information. Note that the bus is an example, and the functional units may be connected to one another via another configuration. In the present embodiment described herein, the display unit 305 and the operation unit 306 exist inside the shape generation apparatus 102. However, no such limitation is intended. For example, the shape generation apparatus 102 may include an interface for connecting to at least one of the display unit 305 and the operation unit 306 prepared outside of the shape generation apparatus 102 and does not need to include the display unit 305 and the operation unit 306 internally.

Returning to FIG. 1, the functional configuration of the shape generation apparatus 102 will now be described. The shape generation apparatus 102 includes, as functions, a shape generation information obtaining unit 111, a generation parameter calculation unit 112, and a visible camera information generation unit 113, for example. Also, the shape generation apparatus 102 includes a foreground image obtaining unit 114, a first voxel set defining unit 115, a second voxel set defining unit 116, a visible camera information selecting unit 117, a voxel determination unit 118, and a voxel output unit 119. Generally speaking, the visible camera information is generated by the shape generation information obtaining unit 111, the generation parameter calculation unit 112, and the visible camera information generation unit 113. Also, a shape model is generated and output by the foreground image obtaining unit 114, the first voxel set defining unit 115, the second voxel set defining unit 116, the visible camera information selecting unit 117, the voxel determination unit 118, and the voxel output unit 119. These functional units will be described below in detail. Note that these functional units, for example, may be implemented by the CPU 301 executing a program stored in at least one of the above-described ROM 302, the RAM 303, or the auxiliary storage apparatus 304. Also, the configuration of FIG. 1 is an example, and additional functional blocks may be prepared. Also, a portion of the functional blocks may be configured as one functional block with another functional block, and one functional block may be divided into a plurality of functional blocks.

The shape generation information obtaining unit 111 obtains information of the camera parameter, the number of cameras, the shape generation region size, and the amount of memory (hereinafter referred to as “visible camera information amount”) that can be used in the visible camera information. The camera parameters are calculated by extracting and associating feature points from marker images for camera calibration captured by each camera in advance and performing calibration of each camera while performing optimization to minimize errors when corresponding points are projected onto the individual cameras. Note that the marker image is a checkerboard, for example. The calibration method may be any selected from known methods. Note that it is sufficient that the camera parameters according to the present embodiment are obtained once at the time of activation of the shape generation apparatus 102 in the pre-preparation stage. The number of cameras is the number of the cameras 221 to 224 constituting the image capturing apparatus 101. The number of cameras may be described in an apparatus settings file or the like and may be obtained by the shape generation information obtaining unit 111 reading this settings file. Also, the shape generation information obtaining unit 111 may obtain the information of the number of cameras by counting the number of camera parameters or the like.

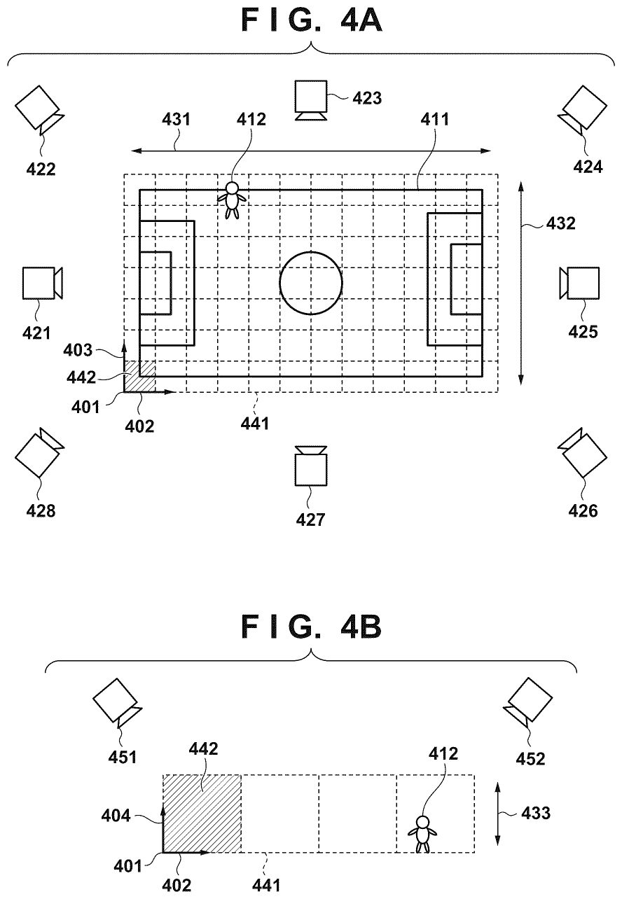

The shape generation region size is the size of the three-dimensional region that is the target of shape model generation. This will now be described using FIGS. 4A and 4B. An origin 401, an Xw-axis 402, a Yw-axis 403, and a Zw-axis 404 in FIGS. 4A and 4B correspond to the origin 241, the Xw-axis 242, the Yw-axis 243, and the Zw-axis 244 illustrated in FIG. 2A, respectively. Also, a field 411 of FIG. 4A corresponds to the field 201 of FIG. 2A, and a subject 412 corresponds to one of the subjects 211 to 213 of FIG. 2A. Also, cameras 421 to 428 of FIG. 4A and cameras 451 to 452 of FIG. 4B correspond to the cameras 221 to 224 of FIG. 2A. As illustrated in FIG. 4A, in the case of generating a shape model of a player on the soccer field as the subject 412, a width 431 and a width 432 in the Xw-axis 402 and Yw-axis 403 direction respectively are set as the shape generation region size corresponding to the size of the field. Note that the players playing outside of the field may be taken into account, and the shape generation region size may be increased by a predetermined width (for example, 1 m from each side of the field or the like) from the field size and set, for example. Also, as illustrated in FIG. 4B, the height of players or the height of jumps may be taken into account, and a width 433 in the Zw-axis 404 direction may also be set.

The shape generation region size is, for example, stored in the settings file of the shape generation apparatus 102 generated by a user input or the like. In a similar manner, the visible camera information amount is also stored in the settings file of the shape generation apparatus 102 or the like. The visible camera information amount may be designated by a user within a range that does not increase the memory size to beyond that physically usable, for example. The shape generation apparatus 102 can obtain the shape generation region size and the visible camera information amount by reading the settings file.

The generation parameter calculation unit 112 calculates the length of one side of one partial region (for example, partial region 441 or 442) used at the time of visible camera information generation based on the shape generation region size (the widths 431 to 433), the number of cameras, and the visible camera information amount. The length of one side of the partial region may be referred to below as the partial region size.

The visible camera information generation unit 113 defines (sets) the partial regions 441 to 442 based on the shape generation region size and the partial region size. Also, the visible camera information generation unit 113, per partial region, generates information (visibility data) indicating whether or not the partial region is visible from each camera (in other words, whether or not at least a portion of the partial region is included in the range of the field of view of each camera). The processing of the visible camera information generation unit 113 will be described below in detail. The visibility data may express whether or not the partial region associated with the visibility data is visible from one camera using 1-bit data. For example, the camera may be designated by the bit position of the visibility data, and for the bit position, in a case where the target partial region is visible from the designated camera, the bit is set to “1”, and in a case where the partial region is not visible from the camera, the bit is set to “0”. Note that this is an example, and the bit may be set to “0” when the partial region is visible and set to “1” when the partial region is not visible. In a case where the visibility of the partial region by each camera is expressed in this manner, in order to hold the visibility data for cameras numbering 1 to 8, data length of 1-byte (8-bits) is required. For example, in the 1-byte visibility data, the least significant bit may indicate the information of the first camera and the most significant bit may indicate the information of the eighth camera. However, this is an example, and the order may be reversed, for example, and the visibility data may be configured with the most significant bit indicating the information of the first camera. In the present embodiment, a set including a plurality of pieces of visibility data obtained for the partial regions is referred to as visible camera information. Also, a plurality of partial region sizes may be defined, and in this case, visible camera information may be generated per partial region size. For example, in a case where the space is divided, a plurality of partial regions are generated from one partial region, and hierarchies of partial regions are defined, visibility data may be generated for each partial region of each hierarchy, and the visible camera information may be generated with the visibility data of the level combined.

The foreground image obtaining unit 114 receives captured images obtained via image capturing using the image capturing apparatus 101 (the cameras 221 to 224) and generates a foreground image from each of the captured images. Also, the foreground image obtaining unit 114 may obtain the captured images captured in advance and stored in the auxiliary storage apparatus 304, for example, and may generate the foreground image. The foreground image is an image generated by extracting a subject region (foreground region) from a captured image. Foreground region extraction may be performed using a known method such as the background subtraction method, for example. In the background subtraction method, the subject region is extracted by comparing a captured image showing the subject and a background image not showing the subject and calculating the difference. The subject extracted as the foreground region typically indicates a dynamic subject (moving body) with change over time (change in terms of position or shape) in the captured images in a case where image capture is performed from the same direction for a large number of consecutive points in time. For example, a dynamic subject may be, in the case of a sports match, a person such as a player or referee on the field where the match is being played or may be, in addition to a person, a ball or the like in the case of a ball game. Also, a dynamic subject may be, in the case of a concert or entertainment, a singer, a musician, a performer, a presenter, or the like. Note that the foreground image obtaining unit 114 may be prepared so that there is one for each of the plurality of cameras.

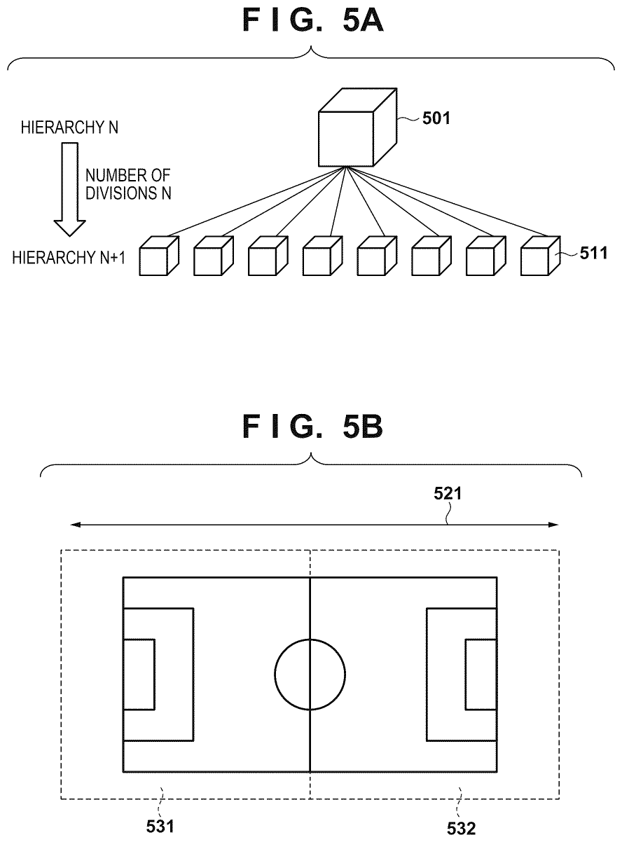

The first voxel set defining unit 115 and the second voxel set defining unit 116 define the voxels using an octree. The shape generation apparatus 102 according to the present embodiment executes efficient processing for shape generation of a region where a subject exists in a wide shape generation region using an octree. An octree is a method of hierarchically generating a shape model of a subject by repeating processing of dividing a voxel, which is a portion of the subject, into eight fine voxels a number of times. Here, as illustrated in FIG. 5A, a pre-divide voxel 501 is referred to as a first voxel, and eight voxels 511 defined by the division of the first voxel are referred to as second voxels. Also, a set including one or more of the first voxels is referred to as a first voxel set, and a set including second voxels after division is referred to as a second voxel set. The first voxel set defining unit 115 defines the first voxel set, and the second voxel set defining unit 116 defines the second voxel set. Here, in the process of repeating the octree processing, the hierarchy of the first voxel of the N-th division (N being the number of divisions) is referred to as hierarchy N, and the hierarchy of the second voxels is referred to as hierarchy N+1. The first voxel set defining unit 115, in a case where the number of divisions is 0, may define a voxel with a shape generation region size 521 as the length of one side as illustrated in FIG. 5B. However, this is an example, and for example, the first voxel set defining unit 115 may define a voxel (a voxel 531 and a voxel 532) with a smaller size, such as half of the voxel with the shape generation region size 521 as the length of one side. In a case where the number of divisions is one or more, the first voxel set defining unit 115 uses the second voxel set obtained at this point in time and defines (updates) the first voxel set based on the processing result of the voxel determination unit 118. The second voxel set defining unit 116 divides the voxel 501 of the first voxel set of the hierarchy N defined by the first voxel set defining unit 115 into eight and defines voxels 511 of the second voxel set of the hierarchy N+1. The octree processing of defining eight fine voxels from one voxel will be described below.

The visible camera information selecting unit 117 selects the visible camera information to use in the voxel determination unit 118 each time division is performed.

The voxel determination unit 118 determines whether or not each voxel of the second voxel set is a portion of the subject based on the foreground image, the camera parameters, and the selected visible camera information. Note that the voxel determination unit 118 performs this determination using the visual hull method. In this determination method, whether or not the processing target voxel is a portion of the subject is determined based on whether or not the voxel is projected into a foreground region captured by each camera. Then, the voxel determination unit 118 determines whether to further repeat or end the octree processing. For example, the voxel determination unit 118 may determine to not repeat the octree processing for voxels that are not a portion of the subject and may determine to repeat the octree processing based on the voxel being a portion of the subject. Here, in a case where the voxel determination unit 118 does not use the visible camera information, the voxel determination unit 118 executes determination processing for all of the cameras used in image capture. However, in the present embodiment, since the visible camera information is generated in advance, it is sufficient that the voxel determination unit 118 executes the determination processing described above for only the cameras for which a partial region including the processing target voxel is visible, and thus the processing amount can be reduced. This determination processing is described below in detail.

The voxel output unit 119 converts the voxels determined to be a portion of the subject into a three-dimensional point group, mesh model, or the like, generates a shape model of the subject, and outputs the shape model to the storing apparatus 103.

The storing apparatus 103 stores the shape model of the subject output from the voxel output unit 119 of the shape generation apparatus 102 in a storage unit 121. Also, the storing apparatus 103 may receive a foreground image obtained by the foreground image obtaining unit 114 of the shape generation apparatus 102 and, in this case, stores the foreground image in the storage unit 121.

### Processing Flow

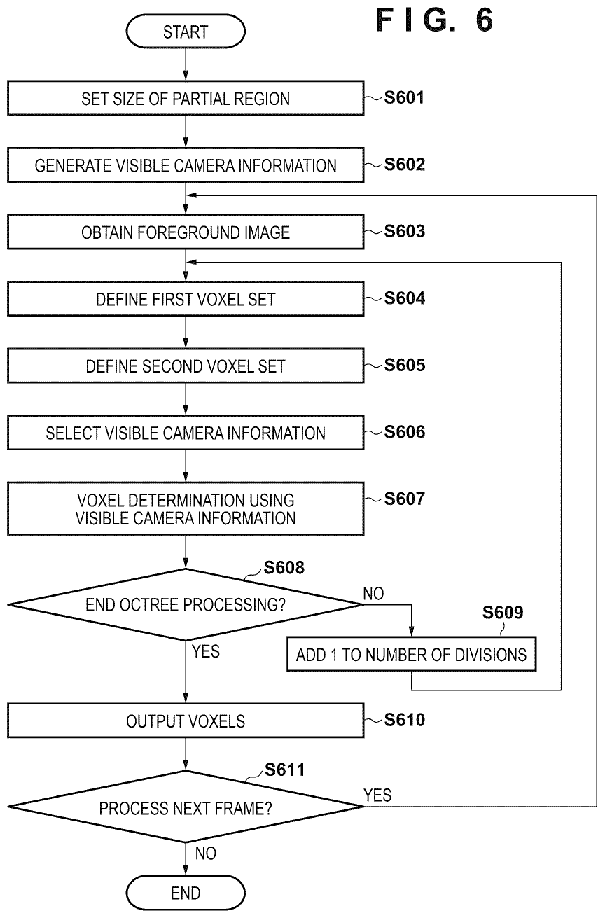

Next, an example of the flow of the processing executed by the shape generation apparatus 102 will be described using FIG. 6. Of the processing illustrated in FIG. 6, in the present embodiment, the processing of S601 and S602 may be executed only once when the shape generation apparatus 102 is activated. Note that this is an example, and after activation, the shape generation apparatus 102 may execute the processing of S601 and S602 again at a constant cycle, for example. However, the shape generation apparatus 102 repeatedly executes the processing of S603 to S611 each time a captured image is received from the image capturing apparatus 101.

### S601

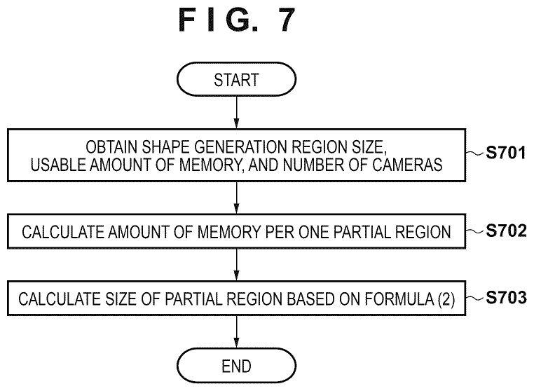

In S601, the CPU 301 sets the size of the partial region. Here, the partial region size setting processing will be described using FIG. 7. First, in S701, the CPU 301 obtains each of the shape generation region size, the visible camera information amount, and the number of cameras via the function of the shape generation information obtaining unit 111. The shape generation region size and the visible camera information amount may be prepared by the user preparing an input parameter of the shape generation apparatus 102 via a text file or the like. In this case, the CPU 301 obtains the shape generation region size and the visible camera information amount by reading the file when the shape generation apparatus 102 is activated. The visible camera information amount is set in such a manner that a memory size totaling the total amount of memory installed in the shape generation apparatus 102 minus the amount required for use in the foreground image and shape model generation is not exceeded. The shape generation region size, for example, may be specified via a sports rule or a field size or the design values of a studio or the like, for example. For example, in the case of soccer, the size of a typical field is 105 meters (m)×68 m. Thus, for the shape generation region size, the size in the horizontal direction may be set to a size greater than or equal to 105 m×68 m. Also, the height is set to 5 m, taking into account the height of a jump by a soccer player, for example. Also, for example, the CPU 301 calculates camera parameters or, in a case where the camera parameters are held in the image capturing apparatus 101, receives the camera parameters from the image capturing apparatus 101 to obtain the camera parameters. Note that the shape generation apparatus 102 may hold the camera parameters of a plurality of cameras belonging to the image capturing apparatus 101. The number of cameras is the number of cameras constituting the image capturing apparatus 101. The CPU 301 may obtain the number of cameras by reading a file with the number of cameras described in advance or may identify the number of cameras by counting the number of camera parameters.

In S702, the CPU 301 calculates the data amount (data amount per one partial region) of the visibility data via the function of the generation parameter calculation unit 112. Since a data length of 1 byte (8 bits) is needed to hold the visible camera information of 1 to 8 cameras, the CPU 301 may calculate the data amount dataSize of the visibility data based on the following Formula (1).

dataSize [byte]=floor((camNum−1)/8)+1 (1)

Here, the variable camNum is the number of cameras, floor(x) is a floor function and is a function that returns the largest integer less than or equal to x. In this manner, the data amount of the visibility data of when the number of cameras is from (8n−7) to 8n is calculated as n bytes. Note that a table indicating the relationship between the number of cameras and the data amount may be prepared, and the data amount of the visibility data may be identified by referencing the table using the number of cameras as an argument.

In S703, the CPU 301 calculates one or more partial region sizes w (length of one side of the partial region) via the function of the generation parameter calculation unit 112. The CPU 301 may calculate the partial region size w in such a manner that the following Formula (2) is satisfied, with the width 431, the width 432, and the width 433 indicating the shape generation region size illustrated in FIGS. 4A and 4B represented as Rx, Ry, and Rz.

Rx/w×Ry/w×Rz/w×dataSize≤usable amount of memory (2)

In other words, the partial region size is determined in such a manner that the usable amount of memory is not exceeded by a value obtained by multiplying the number of partial regions of the entire shape generation region by the data amount of the visibility data. Also, to uniquely determine the partial region size w, the CPU 301 may define the partial region size as 2ⁿ times (n being an integer greater than or equal to 0) the minimum voxel size and may calculate n (and w) satisfying the above-described Formula (2). The minimum voxel size is the voxel size of the shape model that is the output target. Note that the voxel size may be represented by the length of one side of the voxel. In the octree processing described below, to incrementally halve the voxel size, the partial region size is set to be a power of two times the smallest voxel size, allowing the visible camera information including the shape generation region to be efficiently generated (with no fractions). By calculating the partial region size in this manner, visible camera information corresponding to the minimum partial region size (that is, with the highest spatial resolution) can be generated with a limited amount of memory. Also, one piece of visible camera information may be generated per hierarchy of the octree. In this case, the partial region size is also provided per hierarchy. For example, the partial region size is made the same as the voxel size for each hierarchy of the octree. In this manner, the CPU 301 can select visible camera information in accordance with the partial region size for each hierarchy of the octree via the function of the visible camera information selecting unit 117. Furthermore, in the voxel determination processing by the function of the voxel determination unit 118, the CPU 301 can use the selected visible camera information to execute processing at higher speeds and with a lower load compared to when the visible camera information is not used.

### S602

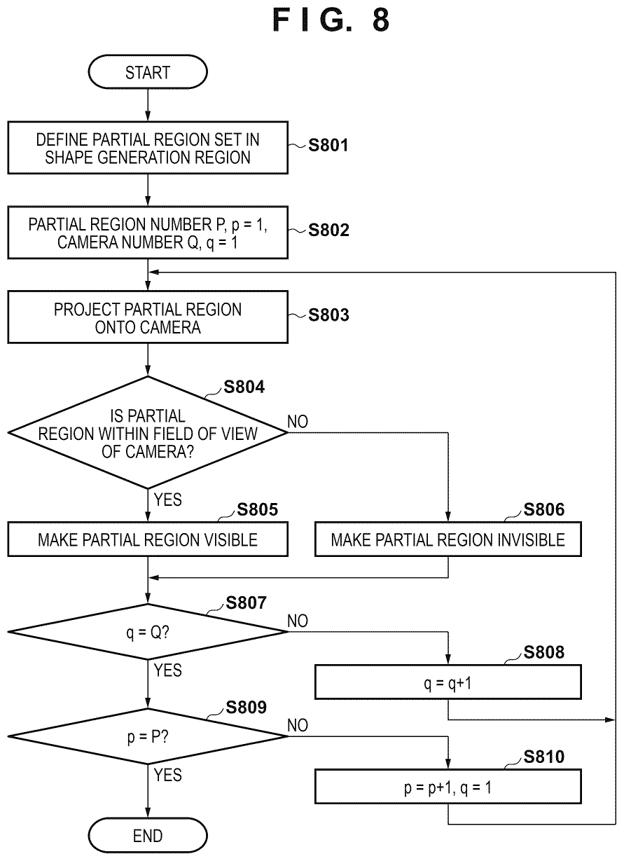

In S602, the CPU 301 uses the function of the visible camera information generation unit 113 to define a partial region set for each of the one or more partial region sizes and generates visible camera information for these. The processing of S602 will now be described in detail using FIG. 8.

In S801, the CPU 301 uses the partial region size w calculated in S703 and defines a partial region set. Each partial region is a cube with one side w formed by eight vertices. The region is divided up from the origin 401 of the shape generation region illustrated in FIG. 4A at w intervals in the direction of the Xw-axis 402 until the shape generation region size (the width 431) is exceeded. In a similar manner, the region is divided up in the Yw-axis 403 and the Zw-axis 404 illustrated in FIGS. 4A and 4B until the shape generation region size (the width 432, the width 433) is exceeded. In this manner, the divided small regions are defined as partial regions. Also, each partial region is provided with partial region coordinates in ascending order in each axis direction. For example, each partial region may be represented using integer values, with the partial region 442 being designated by coordinates (0, 0, 0) and the partial region 441 being designated by coordinates (4, 0, 0). The partial regions are uniquely designated by the partial region coordinates and the number of the partial regions of each axis direction. Note that in a case where the number of the partial regions in the Xw-axis 402, the Yw-axis 403, and the Zw-axis 404 is Nx, Ny, and Nz respectively, for example, the CPU 301 may calculate a partial region ID of a partial region with the partial region coordinates of (X, Y, Z) using the following Formula (3).

Partial region ID=X+Y×Nx+Z×Nx×Ny (3)

Note that each of the partial regions may be designated by partial region coordinates, and the partial region ID for identifying the partial region may be calculated and used. Hereinafter, the partial region ID is used when designating a partial region. The CPU 301 calculates the amount of memory for holding the visible camera information by multiplying the number of defined partial regions by the dataSize calculated in S702 and allocates a memory area with the calculated amount. Also, for example, the CPU 301 may initialize all of the bits of the visible camera information of all of the partial regions to 1 and may make it a state such that all of the partial regions is visible from all of the cameras.

Next, in S802, the CPU 301 executes initialization processing for repeatedly executing the following processing a number of times equal to a number P of all of the partial regions and a number Q of the cameras. In the initialization processing, counters p and q for counting the number of partial regions and the number of cameras for which processing is complete are set to 1. Next, in S803, the CPU 301 projects the three-dimensional coordinates of the eight vertices of the p-th partial region using the camera parameters of the q-th camera and converts the three-dimensional coordinates to the camera image coordinates. Then, in S804, the CPU 301 determines whether the p-th partial region is visible or not visible from the q-th camera. In the determination, the camera image coordinates of the eight vertices calculated in S803 and the image size of the camera are used. First, the CPU 301 determines whether or not the camera image coordinates corresponding to each vertex are included in the area of the image corresponding to the camera field of view (in other words, whether or not each vertex is included in the range of the field of view). In the determination, in a case where Xi of the camera image coordinates is within the horizontal size of the image size and Yi is within the vertical size of the image size, it is determined that the camera image coordinates are included within the field of view. Otherwise, it is determined that the vertex exists outside of the field of view. The image size is a setting value of the image capturing apparatus 101. The CPU 301 may obtain the information of the image size from the image capturing apparatus 101. Also, in a case where a settings file including information of the image size is stored in the auxiliary storage apparatus 304, for example, the CPU 301 may obtain the information of the image size by reading the settings file. Then, in a case where the CPU 301 determines that at least one vertex of the eight vertices is included within the field of view of the camera (YES in S804), in S805, the CPU 301 determines that the processing target partial region is visible from the processing target camera. Here, for example, the CPU 301 sets the bit relating to the processing target camera in the visibility data relating to the processing target partial region to “1”. On the other hand, in a case where the CPU 301 determines that none of the eight vertices are included within the field of view of the camera (NO in S804), in S806, the CPU 301 determines that the processing target partial region is not visible from the processing target camera. Here, for example, the CPU 301 sets the bit relating to the processing target camera in the visibility data relating to the processing target partial region to “0”.

Thereafter, in S807, the CPU 301 determines whether the processing of S803 to S806 is complete for all of the cameras. In a case where there is a camera for which the processing has not been completed (NO in S807), in S808, the CPU 301 increments (increases by one) the counter q and returns the processing to S803. In a case where the CPU 301 determines that the processing of S803 to S806 has been completed for all of the cameras (YES in S807), in S809, the CPU 301 determines whether the processing of S803 to S806 has been completed for all of the partial regions. In a case where there is a partial region for which the processing has not been completed (NO in S809), in S810, the CPU 301 increments the counter p and resets the q to 1 and returns the processing to S803. In a case where the CPU 301 determines that the processing of S803 to S806 has been completed for all of the partial regions and all of the cameras (YES in S809), the CPU 301 ends the processing. Via this processing, the CPU 301 can obtain the visible camera information from each of the plurality of cameras including a set of visibility data indicating whether or not each one of all of the partial regions is visible. Note that the CPU 301 may execute the processing of FIG. 8 for each partial region size and may generate visible camera information for each partial region size. Note that the CPU 301, after generation of the visible camera information, may perform control of the entire shape generation apparatus 102 to put it in a state so that it can receive the foreground image.

In the example described above, in S804, in a case where at least one vertex of the partial region is included within the field of view, the partial region is determined to be visible from the processing target camera. However, no such limitation is intended. In another example, the partial region is determined to be visible from the processing target camera in a case where all of the eight vertices of the partial region are included within the field of view. As an example, which determination method to use may be designated by the user. For example, the determination method may be designated by a settings file of the shape generation apparatus 102, and a determination method reflecting the user's intentions may be used by the settings file being prepared via a user operation. A case in which the partial region is determined to be visible if at least one vertex of the eight vertices of the partial region is within the field of view results in it being easier to determine that the partial region is visible compared to a case in which the partial region is determined to be visible if all of the eight vertices are within the field of view. As a result, in the voxel determination processing, the number of cameras that are the target of processing for determining whether or not a voxel is a portion of a subject in each camera increases. In the visual hull method used in the present embodiment, when the number of cameras with different fields of view increases, the number of blind spot regions in the three-dimensional space which is not visible from any camera decreases, improving the accuracy of the generated model. Thus, by performing a determination of the visibility of the partial region based on whether or not at least one vertex of the eight vertices is included within the field of view, a highly accurate shape model can be generated. On the other hand, a case of determining whether the partial region is visible based on whether or not all of the eight vertices of the partial region are included within the field of view results in the number of cameras for which the partial region is determined to be visible to be reduced compared to a case of determining based on whether or not one vertex is included within the field of view. In this case, in the voxel determination processing, the number of cameras that are the target of processing for determining whether or not a voxel is a portion of a subject in each camera decreases, which reduces the processing load. Thus, depending on whether it is more important to have a shape model with high accuracy or a reduced processing load, the processing to be used may be changed. Note that the system may be implemented in such a manner that one determination method is fixed for use.

### S603

Returning to FIG. 6, in S603, the CPU 301, via the function of the foreground image obtaining unit 114, obtains a captured image captured by the camera of the image capturing apparatus 101 and extracts a foreground image. Also, the CPU 301 may obtain the foreground image extracted by the image capturing apparatus 101 from the image capturing apparatus 101. In a case where the CPU 301 has obtained the captured image, the CPU 301 generates a silhouette image of the subject from the captured image. A silhouette image may be generated from the captured image capturing the subject using a typical method such as the background subtraction method of calculating the difference from a background image of a ground before the start of a match or the like captured in advance at a time when the subject does not exist. However, this is an example, and, for example, a method of recognizing the subject (a human body) or the like may be used to extract a region of the subject and generate a silhouette image. In a case where the CPU 301 has obtained the foreground image, the silhouette image may be generated by deleting the texture information. For example, the CPU 301 generates the silhouette image by making the pixel value of regions where the subject does not exist 0 and the pixel value of subject regions a value other than 0. Note that the image capturing apparatus 101 may generate the silhouette image, and the CPU 301 may obtain the generated silhouette image from the image capturing apparatus 101.

### S604

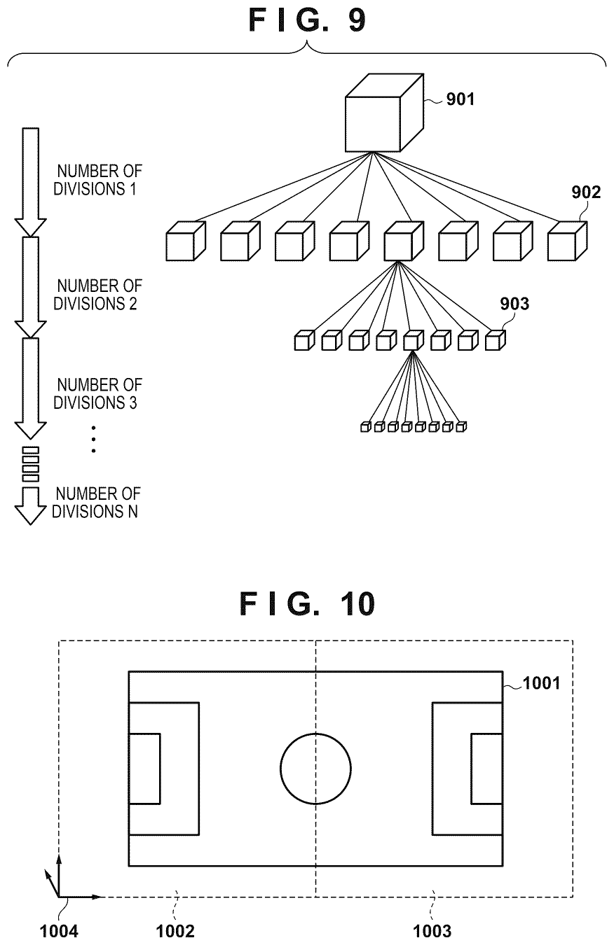

In S604, the CPU 301 defines the first voxel set of the hierarchy N via the function of the first voxel set defining unit 115. In the tree structure of an octree such as that illustrated in FIG. 9, the first voxel set (voxel 901) at 0 for the number of divisions corresponds to the root of the tree structure. The hierarchy of the octree with the voxel 901 is set to hierarchy 0, the hierarchy of a voxel 902 is set to hierarchy 1, the hierarchy of a voxel 903 is set to hierarchy 2, and so on with the hierarchy increases in number by one each time division is performed. With the number of divisions at 0, a set including a voxel 1002 and a voxel 1003 is defined surrounding a play area 1001 illustrated in FIG. 10. For example, in the case of soccer, the standard size of the play area 1001 is 105 m×68 m. In the octree, the voxel size of each hierarchy is halved each time a division is performed. Thus, if the minimum voxel size is 10 mm and the maximum number of divisions is 13 times, the voxel size at the hierarchy 0 is 10 mm×2¹³=81.92 m. With point 1004 as the origin, two voxels, such as the voxel 1002 and the voxel 1003, are defined, and the first voxel set sufficiently including the soccer field is defined. The number of voxels defined does not need to be two, and the voxel size may be further halved and four voxels may be defined, or the voxel size may be doubled and one large voxel may be defined. Also, each voxel holds information of whether or not the voxel is a portion of the subject as a voxel value. For example, a voxel outside of the subject is represented by 0, and a voxel including even a portion of the subject is represented by 1. The voxel values of the first voxel set at 0 for the number of divisions may initially each be set to “1”, for example.

### S605

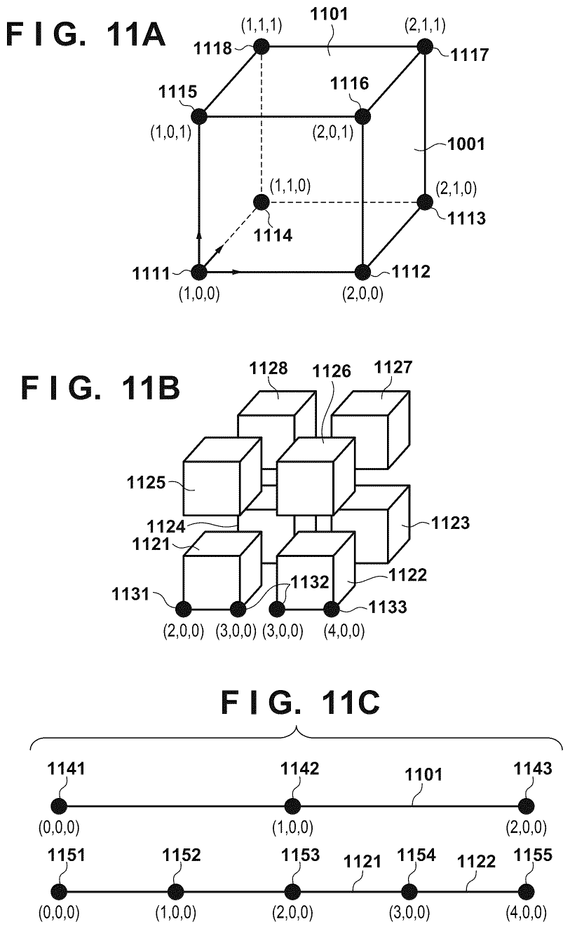

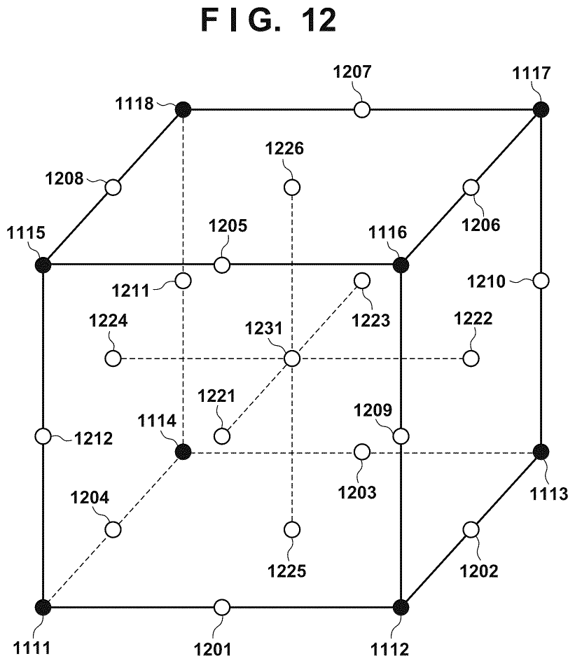

In S605, the CPU 301, via the function of the second voxel set defining unit 116, defines the second voxel set by dividing all of the voxels in the first voxel set defined in S604 into eight fine voxels. The voxel values of the newly defined second voxel set may initially each be set to “1”, for example. A method of dividing one voxel of the first voxel set into eight fine voxels of the second voxel set will be described with reference to FIGS. 11A to 11C and FIG. 12. FIG. 11A illustrates a divided voxel 1101 and eight vertices 1111 to 1118 forming the voxel 1101. Each vertex has voxel coordinates. The voxel coordinates are defined in such a manner that the values increase by 1 every time they move by the amount of the voxel size from the origin 401 of the shape generation region illustrated in FIGS. 4A and 4B in the Xw-axis 402, Yw-axis 403, and Zw-axis 404 direction. In other words, the voxel coordinates of the eight vertices of the one voxel are (a, b, c), (a+1, b, c), (a+1, b+1, c), (a, b+1, c), (a, b, c+1), (a+1, b, c+1), (a+1, b+1, c+1), and (a, b+1, c+1). In the example of FIG. 11A, (a, b, c) equals (1, 0, 0). When the voxel is divided, the new voxel coordinates are associated with the post-division voxels in accordance with the voxel size. When the voxel 1101 of FIG. 11A is divided once, eight fine voxels 1121 to 1128 are defined as illustrated in FIG. 11B.

The vertices newly generated upon division are illustrated in FIG. 12. The positions where the new vertices are generated are midpoints 1201 to 1212 of each side formed by two vertices of the voxel 1101, midpoints 1221 to 1226 of each face formed by four vertices, and a voxel center point 1231. The post-division voxel is defined using the pre-division voxel vertices and the newly generated vertices. For example, the voxel 1121 is defined using the pre-division voxel vertex 1111 and the newly generated vertices, the point 1201, the point 1225, the point 1204, the point 1212, the point 1221, the point 1231, and the point 1224. The voxels 1122 to 1127 are defined in a similar manner. For example, the voxel 1122 is defined using the pre-division voxel vertex 1112 and the newly generated vertices, the point 1202, the point 1225, the point 1201, the point 1209, the point 1222, the point 1231, and the point 1221. The voxel 1123 is defined using the pre-division voxel vertex 1113 and the newly generated vertices, the point 1203, the point 1225, the point 1202, the point 1210, the point 1223, the point 1231, and the point 1222. Also, the voxel 1127 is defined using the pre-division voxel vertex 1117 and the newly generated vertices, the points 1207, 1226, 1206, 1210, 1223, 1231, and 1222. Since the voxel 1121 and the voxel 1122 are adjacent voxels that share a plane, the voxel 1121 and the voxel 1122 are defined using four shared vertices (the point 1201, the point 1225, the point 1231, and the point 1221). Since the voxel 1101 and the voxel 1103 are adjacent and share a side, the voxel 1101 and the voxel 1103 are defined using two shared vertices (the point 1225 and the point 1231). Also, since the voxel 1101 and the voxel 1107 are adjacent and share a point, the voxel 1101 and the voxel 1107 are defined using one shared vertex (the point 1231). As described above, the CPU 301 newly generates vertices and defines the eight voxels from the one voxel.

Next, a method of calculating the voxel coordinates of the second voxel set from the voxel coordinates of the first voxel set will be described with reference to FIGS. 11A to 11C. As illustrated in FIGS. 11A and 11B, when the voxel is divided once, two voxels are generated in each side direction of the voxel. Thus, when the hierarchy is increased by one, the number of voxels in each side direction is doubled. Here, the vertex with the voxel coordinates (Vx, Vy, Vz) in the hierarchy N takes the voxel coordinates (2Vx, 2Vy, 2Vz) in the hierarchy N+1. Also, the voxel coordinates (Vx+1, Vy, Vz) one adjacent from the voxel coordinates (Vx, Vy, Vz) in the hierarchy N take the voxel coordinates (2Vx+2, 2Vy, 2Vz) in the hierarchy N+1. Also, in the hierarchy N+1, the voxel coordinates of the vertex newly generated between two vertices represented by the voxel coordinates (2Vx, 2Vy, 2Vz) and (2Vx+2, 2Vy, 2Vz) becomes (2Vx+1, 2Vy, 2Vz) by calculating the average. An example of calculating the voxel coordinates will now be described using FIG. 11C. To facilitate description, point 1141 to point 1143 of FIG. 11C are illustrated only in terms of their component of the Vx-axis direction that passes through the origin of the voxel coordinate values of FIG. 11A, with each of these corresponding to the origin, the vertex 1111, and the vertex 1112. In other words, the section between the point 1142 and the point 1143 corresponds to the voxel 1101 of FIG. 11A. When the voxel 1101 of FIG. 11A is divided into the eight voxels illustrated in FIG. 11B, point 1152 is defined in the center of point 1151 and point 1153 corresponding to the point 1141 and the point 1142. Also, point 1154 is defined in the center of the point 1153 and point 1155 corresponding to the point 1142 and the point 1143. At this time, the voxel coordinates (0, 0, 0) of the point 1141 is the origin, and thus the corresponding post-division point 1151 also has the voxel coordinates (0, 0, 0). However, the voxel coordinates of the post-division point 1153 corresponding to the voxel coordinates (1, 0, 0) of the point 1142 become (2, 0, 0) with each component being doubled. In a similar manner, the voxel coordinates of the post-division point 1155 corresponding to the voxel coordinates (2, 0, 0) of the point 1143 become (4, 0, 0) with each component being doubled. Also, since the point 1152 is a midpoint between the point 1151 and the point 1153, the voxel coordinates become (1, 0, 0), and in a similar manner, since the point 1154 is a midpoint between the point 1153 and the point 1155, the voxel coordinates become (3, 0, 0). The section between the point 1153 and the point 1154 and the section between the point 1154 and the point 1155 obtained in this manner correspond to the voxel 1121 and the voxel 1122 of FIG. 11B, respectively.

Note that the voxel coordinates in the hierarchy N+1 of the center of each plane of the pre-division voxel in the hierarchy N may be calculated as the average value of the voxel coordinates in the hierarchy N+1 of the four vertices forming the plane. For example, the voxel coordinates of the center of the plane including the four vertices with the voxel coordinates (2Vx, 2Vy, 2Vz), (2Vx+2, 2Vy, 2Vz), (2Vx+2, 2Vy+2, 2Vz), (2Vx, 2Vy+2, 2Vz) are (2Vx+1, 2Vy+1, 2Vz). Also, the voxel coordinates in the hierarchy N+1 of the center of the pre-division voxel in the hierarchy N may be calculated as the average value of the voxel coordinates in the hierarchy N+1 of the eight vertices forming the voxel. For example, the voxel coordinates in the hierarchy N+1 of the center of the voxel with the voxel coordinates (Vx, Vy, Vz) closest to the origin in the hierarchy N are (2Vx+1, 2Vy+1, 2Vz+1).

Also, the CPU 301 allocates a voxel ID to each voxel in such a manner that each voxel can be uniquely designated. The CPU 301 may calculate the voxel ID via the following Formula (4) using the voxel coordinates (Vx, Vy, Vz) set at the closest point to the origin from among the corresponding voxel vertices.

Voxel ID=Vx+Vy×Vxnum+Vz×Vxnum×Vynum (4)

Note that Vxnum, Vynum, and Vznum are each voxel numbers of the Xw-axis, the Yw-axis, and the Zw-axis, respectively. The voxel number (Vxnum, Vynum, Vznum) of each direction may be calculated by dividing the length in each direction (the width 431 to the width 433 in FIGS. 4A and 4B) of the shape generation region by the length of one side of the voxel.

### S606

Returning to FIG. 6, in S606, the CPU 301 determines whether or not to use the visible camera information (in the processing of S607 described below) via the function of the visible camera information selecting unit 117. Then, in a case where the CPU 301 determines to use the visible camera information, the CPU 301 selects one piece of visible camera information to use from among the one or more pieces of visible camera information.

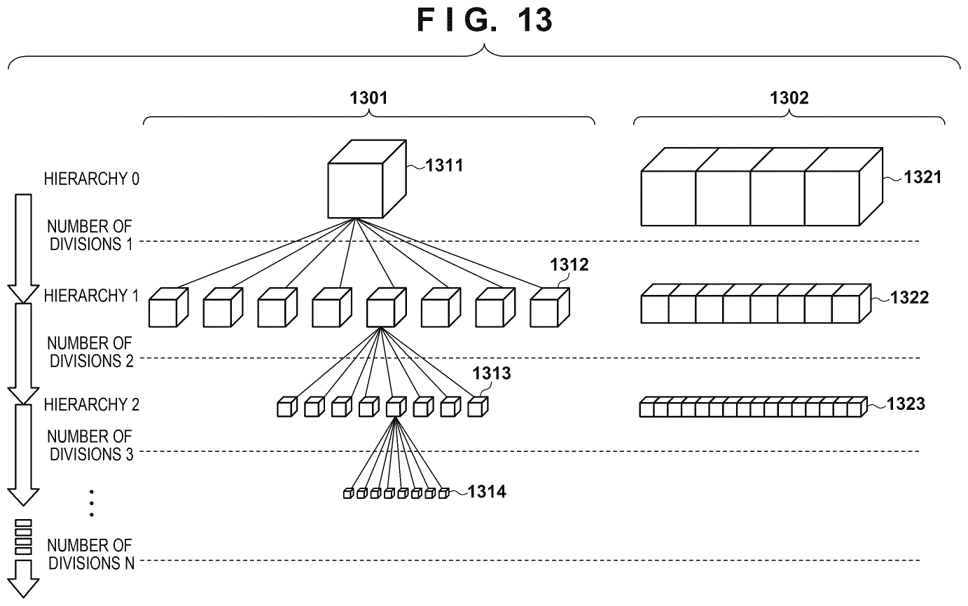

This method of determining and selecting whether or not to use the visible camera information will now be described with reference to FIG. 13. In FIG. 13, the diagram on the left side denoted by a reference number 1301 is a diagram schematically illustrating divisions of voxels via the octree, and the diagram on the right side denoted by a reference number 1302 is a schematic view of visible camera information generated for each partial region size. Here, a voxel 1311 and visible camera information 1321 of the hierarchy 0 are associated together, a voxel 1312 and visible camera information 1322 of the hierarchy 1 are associated together, and a voxel 1313 and visible camera information 1323 of the hierarchy 2 are associated together. Also, a voxel 1314 is not associated with visible camera information. The CPU 301 compares the voxel size of the hierarchy targeted for voxel determination and the partial region size of each piece of visible camera information. Then, the CPU 301 selects for use the visible camera information corresponding to the partial region size closest to the voxel size from among the pieces of visible camera information with a partial region size greater than or equal to the voxel size. For example, for the voxel 1311, the visible camera information 1321 is selected, and for the voxel 1312, the visible camera information 1322 is selected. Note that the voxel size and the partial region size of the visible camera information do not need to match. It is sufficient that the voxel size is less than or equal to the partial region size, and for example, even if visible camera information with partial region size of the same size as the voxel size of the voxel 1314 is not generated, the CPU 301 can select the visible camera information 1323. Also, in a case where visible camera information corresponding to a partial region size greater than the size of the determination target voxel does not exist, the CPU 301 may determine to not use visible camera information for that voxel. According to this method, even in a case where only one of the visible camera information 1323 is generated and the other visible camera information 1321 and 1322 are not generated, use of the visible camera information can be determined for each hierarchy. For example, the CPU 301 compares the voxel size of each hierarchy and the partial region size of the only one generated visible camera information. Then, if the voxel size is less than or equal to the partial region size corresponding to the visible camera information, the CPU 301 determines to use the visible camera information. Also, in a case where there is no visible camera information corresponding to a partial region size greater than or equal to the voxel size for each hierarchy, the CPU 301 may determine not to use visible camera information.

S607

In S607, the CPU 301 determines whether or not each voxel of the second voxel set is a portion of the subject via the function of the voxel determination unit 118. The CPU 301 determines whether or not the determination target voxel is a portion of the subject by determining whether the voxel is projected into the foreground region in a silhouette image when the voxel is projected onto a silhouette image corresponding to the camera which has the voxel within its field of view. Then, in a case where the number of cameras for which the voxel is projected into the foreground region is greater than or equal to a preset threshold, the CPU 301 determines that the voxel is a portion of the subject. On the other hand, in a case where the number of cameras for which the voxel is projected into the foreground region is less than the threshold, the CPU 301 determines that the voxel is not a portion of the subject. Here, the CPU 301 can use the visible camera information selected in S606 in the determination of whether or not the voxel is within the field of view of the camera. The CPU 301 obtains the visibility data corresponding to (for the partial region including) the voxel and determines that the voxel is visible from the cameras that correspond to a bit set to “1” in the visibility data. Then, the CPU 301 projects the voxel onto the camera and performs determination of whether the voxel is a portion of the subject. For cameras that correspond to a bit set to “0” in the visibility data, the CPU 301 determines that the voxel is not visible and, for that camera, does not perform projection of the voxel and does not perform determination of whether the voxel is a portion of the subject. Also, in S606, in a case where it is determined to not use visible camera information, the CPU 301 projects the voxel onto all of the cameras and performs determination of whether the voxel is a portion of the subject.

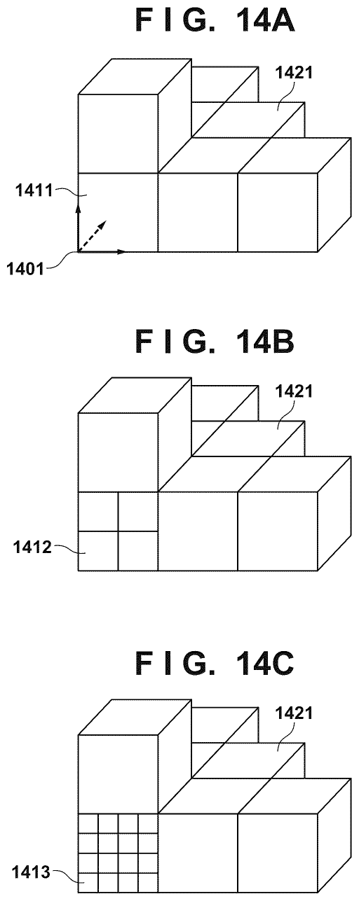

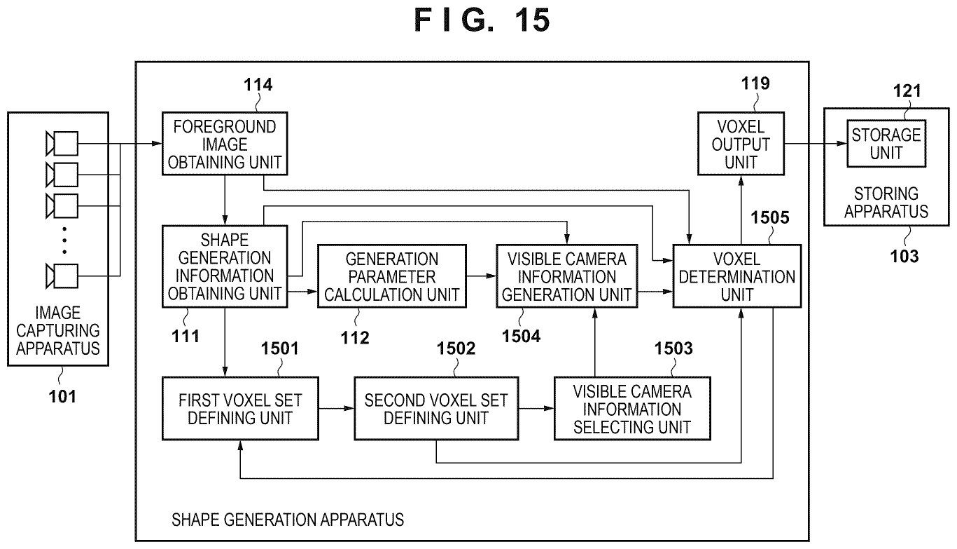

A method of obtaining the visibility data of the partial region corresponding to the voxel from the visible camera information will now be described with reference to FIGS. 13 and 14A to 14C. First, consider an example in which the partial region size of the visible camera information selected for the hierarchy N of the octree illustrated in FIG. 13 is the same as the voxel size in the hierarchy N. In this case, in the space of the world coordinate system of an origin 1401 as illustrated in FIG. 14A, partial regions 1421 with the same size as each of one or more voxels 1411 are each arranged at equal intervals along each side of the shape generation region. In this case, since the voxel number and the partial region number are the same, the voxel ID of one voxel matches the partial region ID of the partial region corresponding to the voxel (at least a one-to-one correspondence). Thus, the CPU 301 can uniquely identify the corresponding one partial region ID from the voxel ID for each voxel.

Next, an example in which the partial region size of the visible camera information selected for the hierarchy N is the same as the voxel size of hierarchy N−1 will be looked at. In this case, as illustrated in FIG. 14B, in the space of the world coordinate system, since the size of a voxel 1412 and the size of the partial region 1421 are different, the voxel ID and the partial region ID do not match (not a one-to-one correspondence). Here, the voxel ID for the voxel of the hierarchy N−1 (of the division source of the voxel) corresponding to the voxel of the hierarchy N is identified, and the partial region ID that matches (has a one-to-one correspondence with) the voxel ID is identified. The voxel ID for the voxel of hierarchy N−1 can be identified by calculating the voxel coordinates of the voxel. The voxel coordinates of the voxel of the hierarchy N−1 are obtained by calculating the quotient (truncated at the decimal point) of dividing the voxel coordinates of the voxel of the hierarchy N by 2. According to this calculation, for the pre-division voxel corresponding to the eight post-division voxels, the same voxel coordinates are calculated and, as a result, only one voxel ID is identified. Accordingly, since the voxel size of the voxel in the hierarchy N−1 and the partial region size match (one-to-one correspondence), the CPU 301 can uniquely designate the partial region with prepared visible camera information using the voxel ID of the voxel. Also, the CPU 301 can obtain the visibility data corresponding to the partial region as the visibility data to be used for the voxel of the hierarchy N.

Next, an example in which the partial region size of the visible camera information selected for the hierarchy N is the same as the voxel size of hierarchy N−2 will be looked at. In this case also, as illustrated in FIG. 14C, in the space of the world coordinate system, since the size of a voxel 1413 and the size of the partial region 1421 are different, the voxel ID and the partial region ID do not match. Here, the CPU 301 identifies the voxel of the hierarchy N−1 (of the division source of the voxel) corresponding to the voxel of the hierarchy N−2, further identifies the voxel of the hierarchy N corresponding to the voxel of the hierarchy N−1, and identifies the voxel ID of this voxel. The voxel coordinates of the voxel of the hierarchy N−2 are obtained by calculating the quotient (truncated from the decimal point) of dividing the voxel coordinates of the voxel 1413 of the hierarchy N by 4. According to this calculation, for the voxel of two divisions prior corresponding to the 64 voxels of two divisions after, the same voxel coordinates are calculated and, as a result, only one voxel ID is identified. Accordingly, since the voxel size of the voxel in the hierarchy N−2 and the partial region size match (one-to-one correspondence), the CPU 301 can uniquely designate the partial region with prepared visible camera information using the voxel ID of the voxel. Also, the CPU 301 can obtain the visibility data corresponding to the partial region as the visibility data to be used for the voxel of the hierarchy N.

In this manner, in a case where the partial region size corresponding to the visible camera information to be used for the voxel of the hierarchy N matches the voxel size of hierarchy N−n, the CPU 301 divides the voxel coordinates of the voxel by 2ⁿ and identifies the voxel coordinates of the hierarchy N−n. Then, the CPU 301 can calculate the voxel ID from the identified coordinates and can obtain the visibility data corresponding to the processing target voxel from the visible camera information corresponding to the partial region ID that matches (one-to-one correspondence) the voxel ID.

A method of determining whether or not a voxel is projected into a foreground region will now be described. First, for the determination target camera, the CPU 301 calculates a distance d from the camera to each voxel by projecting the center point of the voxel onto the camera using the camera parameter. The distance d is obtained by multiplying world coordinates Mw of the center point of the voxel by an extrinsic matrix Te to convert the world coordinates Mw of the center point into coordinates Mc of the camera coordinate system. Te denotes a conversion matrix formed by the extrinsic parameters of the camera. Also, when the direction that the lens of the camera is facing is the positive direction of the z-axis of the camera coordinate system, with the camera position being the origin, the z-coordinate of Mc is identified as the distance d in a case where the point is seen from the camera. Next, image coordinates Mi of Mc are calculated. The image coordinates Mi are calculated by multiplying an intrinsic matrix Ti by normalized camera coordinates obtained by normalization of Mc with the z-coordinate. Ti denotes a matrix formed by the intrinsic parameters of the camera. In a case where the CPU 301 determines that the pixel values for the image coordinates Mi obtained via this calculation are pixel values indicating a foreground region, the CPU 301 determines that the voxel is projected into the foreground region of the camera. Also, in a case where the pixel values for the image coordinates Mi are not pixel values indicating a foreground region or are outside of the field of view, the CPU 301 determines that the voxel is not projected into the foreground region of the camera. Note that in the processing example described above, a determination of whether the center point of the voxel is projected into a foreground region is performed. However, no such limitation is intended. For example, further fine voxels may be defined in the voxel, and whether the subject exists in the voxel may be evaluated. Also, a method including generating an integration image for each camera and evaluating whether a voxel is projected into a foreground region based on the integration image may be used. Also, a method including generating multi-resolution images and evaluating whether a voxel is projected in a foreground region using a foreground image of a resolution that is appropriate for the voxel size may be used. Via these methods, whether or not a voxel is projected into a foreground region can be determined with high accuracy without overlooking the presence of a subject in the voxel. The integration images and multi-resolution images may be generated via a known method.

In a case where the CPU 301 determines that the processing target voxel is outside of the foreground region, the CPU 301 sets a value (for example, 0) meaning outside of the subject region to the voxel value of the voxel and moves the processing to the next voxel. On the other hand, in a case where the CPU 301 determines that the processing target voxel is projected into the foreground region in all of the cameras or in a number of cameras greater than or equal to a set number, the CPU 301 sets a value (for example, 1) meaning the subject region to the voxel value of the voxel and moves the processing to the next voxel.

### S608

In S608, the CPU 301 determines whether or not to end the octree processing in response to determination for all of the voxels of the second voxel set having ended. For example, the CPU 301 evaluates an end condition for determining whether or not to further finely divide the voxels. In a case where the end condition is satisfied, the CPU 301 determines to end the octree processing, and while the end condition is not satisfied, the CPU 301 continues the octree processing. For example, the end condition may be designated to be the number of divisions reaching a preset maximum number of divisions, the voxel size for the hierarchy N reaching a preset minimum voxel size, or the like.

### S609

In a case where the CPU 301 determines that the end condition is not satisfied, in S609, the CPU 301 adds 1 to the number of divisions, returns the processing to S604, and continues the octree processing. Then, in S604, the CPU 301 redefines at least a portion of the second voxel set for which voxel determination is complete as the first voxel set, and in S605, further defines the second voxel set based on the first voxel set and recursively continues the octree processing. Note that the CPU 301 sets a set of only voxels determined to be a portion of the subject (in other words, have a voxel value of 1) from among the second voxel set for which voxel determination is complete as the first voxel set. In other words, voxels that have been determined to not be a portion of the subject are excluded from being the recursive processing target. This can prevent the processing being repeated unnecessarily for voxels that have been determined to not correspond to the subject and can suppress an increase in the processing load.

### S610

In a case where the CPU 301 determines that the end condition is satisfied in S608, the CPU 301 executes the processing of S610. In S610, via the function of the voxel output unit 119, the CPU 301 uses voxels of the second voxel set with a voxel value of 1 to generate a three-dimensional point group and a three-dimensional mesh model and outputs this to the storing apparatus 103. The CPU 301 may collect the center coordinates calculated for each voxel with a voxel value of 1 and generate a three-dimensional point group or may generate a three-dimensional point group using eight vertices. Also, the CPU 301 may extract a set of points forming the surface of the subject from a set of voxels with a voxel value of 1 and convert only the surface voxels into a point group. In this case, for example, for the determination target voxel with a voxel value of 1, the CPU 301 references the voxel values of nearby voxels and, in a case where a voxel with a voxel value of 0 exists nearby, may extract the determination target voxel as a voxel that forms the surface of the subject. Also, the CPU 301 may generate a mesh model from a voxel set using a known method such as the marching cubes method.

### S611

In S611, the CPU 301 determines whether a frame to be processed next exists and, in a case where such a frame does exist, returns the processing to S603. Thereafter, for the next frame, the CPU 301 obtains a foreground image based on the captured images captured by the plurality of cameras and repeatedly executes the following processing. Note that, for example, in a case where a user operation instructing to end the processing is received by the operation unit 306 (for example, via a GUI (not illustrated) or the like), the CPU 301 ends the processing of FIG. 6.

In the present embodiment, as described above, the shape generation apparatus 102 determines the size of the partial region from the amount of memory that can be used for holding the visible camera information at the time of apparatus activation, the size of the shape generation region, and the number of cameras and generates the visible camera information. Accordingly, partial regions are defined at a fineness/coarseness that is appropriate for the apparatus configuration, and visible camera information is generated for each of the partial regions. Also, the shape generation apparatus 102 determines whether or not to use the visible camera information generated in this manner or which visible camera information to use in accordance with the size of the voxels in the octree processing. Accordingly, even in a case where the size of a partial region with defined visible camera information does not necessarily match the voxel size, the shape generation apparatus 102 can execute the octree processing using appropriate visible camera information.

Also, in the example described above, visible camera information is used only in a case where the number of partial regions is greater than the number of the voxels. For example, a camera for which visible is identified in at least one piece of the visibility data of a plurality of partial regions with at least a portion included in the area of the voxel may be used in the determination of the voxel. Thus, according to the present embodiment, visible camera information can be generated for each of the partial regions according to the amount of memory that can be used, and the visible camera information can be used at the appropriate timing in the octree processing.

### Second Embodiment

In the method according to the first embodiment described above, visible camera information is generated at the time of activation of the apparatus before the visible camera information is used in the octree processing. In the method according to the present embodiment described herein, a shape model is generated while the visible camera information is being generated in parallel with the octree processing.

### System Configuration

FIG. 15 illustrates a configuration example of an image processing system according to the present embodiment. Note that the image capturing apparatus 101 and the storing apparatus 103 have the same functional configuration, and the hardware configuration of the shape generation apparatus 102 is similar to that of the first embodiment. Also, of the functional configurations of the shape generation apparatus 102, each block (the shape generation information obtaining unit 111, the generation parameter calculation unit 112, the foreground image obtaining unit 114, and the voxel output unit 119) with a similar function to that in the first embodiment is given the same reference number as in FIG. 1 and description thereof is omitted.

In the present embodiment, while generation of the shape model via the octree processing is being performed, the visible camera information is generated in parallel. Thus, the functions of a first voxel set defining unit 1501 and a second voxel set defining unit 1502 are different from that of the first voxel set defining unit 115 and the second voxel set defining unit 116 of the first embodiment. Also, the functions of a visible camera information selecting unit 1503 and a visible camera information generation unit 1504 are different from that of the visible camera information selecting unit 117 and the visible camera information generation unit 113. Also, the function of a voxel determination unit 1505 is different from that of the voxel determination unit 118.

As illustrated in FIG. 5A, the first voxel set defining unit 1501 defines a set (first voxel set) of the voxels 501 of the hierarchy N within a shape generation region for the number of divisions N of the octree processing. At this time, each voxel has a voxel value. The second voxel set defining unit 1502 defines a set (second voxel set) of the voxels 511 of the hierarchy N+1 obtained by each voxel 501 of the first voxel set being divided into eight voxels. The initial value of the voxel value is passed on from the information of the pre-division voxel. In other words, in a case where, from the first voxel set, only voxels with a voxel value of 1 are divided, the voxel value of all of the voxels included in the second voxel set is initially 1. The octree processing is similar to that of the first embodiment, and thus the description thereof will be omitted.

The visible camera information selecting unit 1503 determines whether or not visible camera information can be generated for the second voxel set based on the available amount of memory, and selects which hierarchy of visible camera information to use in the voxel determination unit 1505. In a case where it is determined by the visible camera information selecting unit 1503 that visible camera information can be generated, the visible camera information generation unit 1504 allocates a memory area for holding the visible camera information. The voxel determination unit 1505 determines whether or not each voxel of the second voxel set is a portion of the subject based on the foreground image and the camera parameters. Also, the voxel determination unit 1505, in the process of advancing the determination processing, also updates the visibility data of the selected visible camera information based on the result of projecting the voxels onto the camera.

### Processing Flow

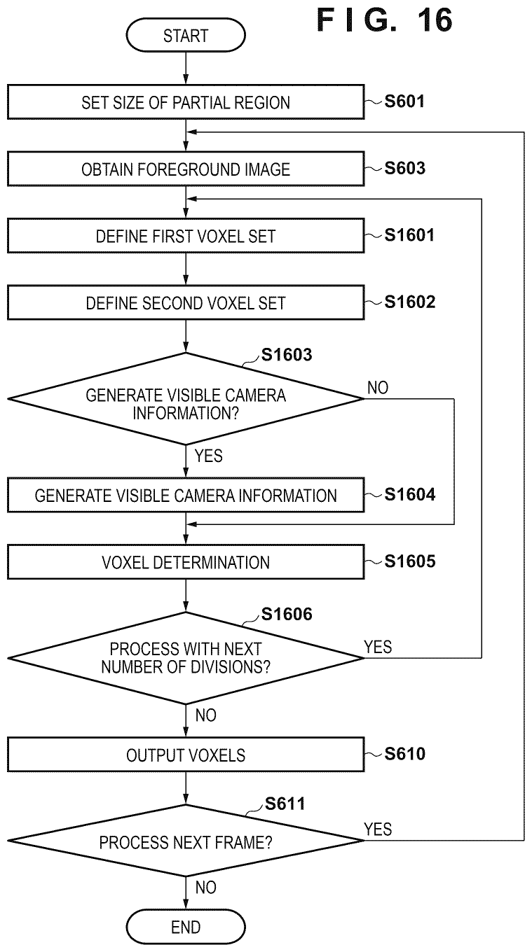

Next, an example of the flow of the processing executed by the shape generation apparatus 102 according to the present embodiment will be described using FIG. 16. The processing of S601, S603, S610, and S611 illustrated in FIG. 16 are similar to that of FIG. 6 and thus will not be described.

### S1601

In S1601, the CPU 301 defines the first voxel set of the hierarchy N via the function of the first voxel set defining unit 1501. Here, as in the first embodiment, in the tree structure of the octree as illustrated in FIG. 9, the hierarchy of the octree with the voxel 901 is set as the hierarchy 0. Furthermore, the hierarchy of the voxels 902 is set to the hierarchy 1, the hierarchy of the voxels 903 is set to the hierarchy 2, and so on, with 1 being added to the number indicating the hierarchy each time division is performed. The first voxel set defining unit defines the first voxel set of the hierarchy 0 for the number of divisions 0 as in S604 of the first embodiment. Here, the CPU 301 sets the voxel value of each voxel to 1 and sets all of the bits corresponding to each camera of the visibility data of the voxel to the visible state. The processing of the number of divisions 1 and onwards will be described below in association with S1606.

### S1602

In S1602, the CPU 301, using the function of the second voxel set defining unit 1502, defines the second voxel set by dividing all of the voxels of the first voxel set defined in S1601 into eight fine voxels. The CPU 301 sets the initial value of each voxel of the second voxel set to 1. The method of dividing the voxels of the first voxel set into the voxels of the second voxel set is as in S605, and thus this will not be described in detail here.

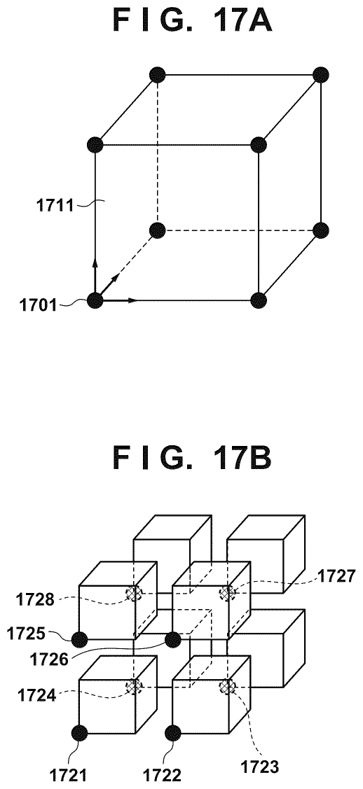

In the present embodiment, since the visible camera information is generated while executing the octree processing, the method of providing the voxel coordinates and the voxel IDs is different from the first embodiment. The method of providing the voxel coordinates and the voxel IDs will now be described using FIGS. 17A and 17B. In the case of dividing a voxel 1711 of the first voxel set illustrated in FIG. 17A into a second voxel set as illustrated in FIG. 17B, the CPU 301 first calculates the voxel coordinates using the same method as the method described in S605. However, in the present embodiment, only 27 patterns of voxel coordinates from (0, 0, 0) to (2, 2, 2) appear. So that world coordinates can be obtained for the visible camera information generation and voxel determination described below, each voxel has world coordinates with a vertex 1701 as the origin of the voxel. Also, when the CPU 301 divides the voxel 1711 into the eight voxels, world coordinates with origins 1721 to 1728 of post-division voxels are calculated from the origin of the pre-division voxel and then stored. These world coordinates can be calculated by adding the result of multiplying the voxel coordinates using the origins 1721 to 1728 of the post-division voxels by the post-division voxel size to the world coordinates with the origin 1701 of the pre-division voxel.

### S1603

In S1603, the CPU 301 determines whether or not visible camera information for use in voxel determination can be generated using the function of the visible camera information selecting unit 1503. In a case where the CPU 301 determines that visible camera information can be generated, the CPU 301 advances the processing to S1604. On the other hand, in a case where the CPU 301 determines that visible camera information cannot be generated, the CPU 301 moves the processing to S1605 without generating visible camera information.

In order to determine whether or not it can generate visible camera information, the CPU 301 calculates the amount of memory required in the case of holding the visible camera information for all of the voxels of the second voxel set. Then, in a case where the amount of memory is less than the usable amount of memory, the CPU 301 determines that visible camera information can be generated. The usable amount of memory is obtained in S701 of FIG. 7. In order to calculate the required amount of memory, the CPU 301 first counts the number of voxels with a voxel value of 1 in the first voxel set for the number of divisions N. In other words, the number of voxels with a voxel value of 1 in the second voxel set of the number of divisions N−1 in S1605, that is, the number of voxels determined to be a portion of the subject, is counted. In the octree processing, the number of voxels of the second voxel set at the number of divisions N is eight times the counted number. Thus, the CPU 301 can calculate the amount of memory required to hold the visible camera information by multiplying the number of voxels of the second voxel set by the visibility data size dataSize per one voxel calculated via Formula (1) described above.

### S1604

In a case where the CPU 301 determines that visible camera information can be generated, in S1604, the CPU 301 uses the function of the visible camera information generation unit 1504 and allocates the memory area required for holding the visible camera information based on the amount of memory calculated relating to the second voxel set. The initial value of the visibility data of each voxel is passed on from the visibility data of the pre-division voxel.

### S1605

In S1605, the CPU 301 determines whether or not each voxel of the second voxel set is a portion of the subject using the function of the voxel determination unit 1505. The CPU 301 uses the visible camera information set in S1604 when performing determination. The method of using the visible camera information is as in S607, but in the present processing, the CPU 301 not only uses the visible camera information but also executes processing to update the visible camera information.

The method of updating the visibility data will now be described. First, based on the visibility data of the voxel, the CPU 301 determines visible for a specific camera if the bit corresponding to the camera ID is 1 and projects the eight vertices (or the center point) of the voxel onto the camera. The world coordinates of the vertices of the projection target voxel are obtained via the method described relating to S1602. For cameras with 0 for the corresponding bit of the visibility data, the CPU 301 executes the processing of the next camera without performing projection of the point of the voxel onto the camera. Here, the visibility data used is visibility data generated for the pre-division voxel size, and thus there is a possibility that incorrect information is set for the post-division voxel size. Regarding this, in a case where a post-division voxel projected onto a camera determined as visible for a pre-division voxel is outside of the field of view, the CPU 301 updates the bit of the camera ID of the visibility data for that voxel to “0” (not visible). Note that for a camera set with not visible in the visibility data of the pre-division voxel, projection of the voxel is not performed, and thus there is no update to visible. Accordingly, when the CPU 301 determines the visibility of the voxel for a specific camera, if the CPU 301 determines that even one from among all of the vertices projected onto the camera is within the field of view, the CPU 301 may determine that the target voxel is visible from the camera. Accordingly, the probability of not visible being erroneously set in the visibility data for a specific voxel for a specific camera which should be visible for the voxel can be reduced. In a case where the processing target voxel is projected within the field of view of the processing target camera and it is determined that the processing target voxel is not a portion of the subject, the CPU 301 sets the bit of the visibility data corresponding to the camera to 1 and sets the voxel value of the voxel to 0.

Note that in a case where the CPU 301 determines that visible camera information cannot be generated in S1604 and generated visible camera information for a low hierarchy is held, in S1605, this visible camera information may be used. In other words, in a case where visible camera information generated corresponding to a pre-division voxel of the processing target voxel or a voxel with a larger size that included the pre-division voxel exists, that visible camera information may be used. On the other hand, in a case where visible camera information that can be used is not held, the CPU 301 executes the processing of S1605 without using visible camera information.

### S1606

In S1606, the CPU 301 determines whether to end the octree processing or further finely divide the voxels via the function of the voxel determination unit 1505. For example, the CPU 301 evaluates an end condition for determining whether or not to further finely divide the voxels. In a case where the end condition is satisfied, the CPU 301 determines to end the octree processing, and while the end condition is not satisfied, the CPU 301 continues the octree processing. The end condition is similar to that described in relation to S608. However, in the present embodiment, for the set of voxels determined to be a portion of the subject in the voxel determination result of the second voxel set of the number of divisions N, when the first voxel set of the number of divisions N+1 is defined, the visibility data of the voxels may be passed on. Also, the second voxel set of the number of divisions N+1 is further defined, and the octree processing is recursively continued. In a case where the CPU 301 ends the octree processing, the CPU 301 executes the processing of S610 using the second voxel set of the final hierarchy.

According to the present embodiment, the shape generation apparatus 102 can generate a shape model while generating visible camera information during octree processing. According to this processing, even in the case of processing a large shape generation region, it is sufficient that, for processing, the shape generation apparatus 102 holds visible camera information only for the partial regions in which the subject exists. Thus, high-speed shape generation processing can be executed with the amount of memory used being kept to a minimum.

Note that in the embodiments described above, the size of the partial region with the generated visible camera information is determined according to the number of cameras, but no such limitation is intended. For example, it may be configured such that the size of the visibility data for one partial region is a constant size (that is sufficiently large, for example), regardless of the number of cameras. In this case, the result of dividing the usable amount of memory by the size of the visibility data corresponds to the maximum number of partial regions that can be defined. Accordingly, depending on the shape of the shape generation region, the number of partial regions of each axis (size of the partial regions) may be determined in such a manner that the product of the number of partial regions in each of the Xw-axis, the Yw-axis, and the Zw-axis does not exceed the number of definable partial regions. In other words, in the example described above, the size of the partial region is identified based on the usable amount of memory and the number of cameras. However, instead of the number of cameras, the data size of the visibility data may be used when identifying the size of the partial region.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-018549, filed Feb. 6, 2025, which is hereby incorporated by reference herein in its entirety.

What is claimed is:

1. A shape generation apparatus that generates a shape model of a subject using captured images captured using a plurality of cameras, comprising:
one or more processors; and
one or more memories that store a computer-readable instruction for causing, when executed by the one or more processors, the one or more processors to perform a control method comprising:
generating visible camera information indicating whether or not each of partial regions is visible from each of the plurality of cameras, the partial regions being obtained by dividing a shape generation region for which the shape model is to be generated;
defining a plurality of voxels in the shape generation region;
determining whether each voxel included in the plurality of voxels is a portion of the subject by not projecting the voxel onto a camera for which the partial region corresponding to the voxel is not visible according to the visible camera information and projecting the voxel onto a camera for which the partial region corresponding to the voxel is visible according to the visible camera information;
outputting the shape model of the subject based on a result of the determining; and
determining a size of a partial region based on a size of the shape generation region, a memory amount indicating an amount of memory available for holding the visible camera information, and information relating to a data size of data indicating whether one voxel is visible from each of the plurality of cameras.

2. The shape generation apparatus according to claim 1, wherein
the information relating to the data size is a total number of the plurality of cameras.

3. The shape generation apparatus according to claim 1, wherein
the visible camera information is generated for each of a plurality of sizes of a partial region, and
whether each of the plurality of voxels is a portion of the subject is determined using the visible camera information for a partial region of a size corresponding to a size of each of the plurality of voxels.

4. The shape generation apparatus according to claim 3, wherein
whether each of the plurality of voxels is a portion of the subject is determined using the visible camera information for, from among partial regions of a size greater than or equal to the size of each of the plurality of voxels, a partial region of a size closest to the size of the voxel.

5. The shape generation apparatus according to claim 3, wherein
in a case where the visible camera information does not exist for a partial region of a size greater than or equal to the size of each of the plurality of voxels, whether each of the plurality of voxels is a portion of the subject is determined by projecting each of the plurality of voxels onto the plurality of cameras.

6. The shape generation apparatus according to claim 1, wherein
the size of a partial region is determined in such a manner that a total number of the partial regions defined in the shape generation region does not exceed a value obtained by dividing the memory amount by the data size.

7. The shape generation apparatus according to claim 1, wherein
the size of a partial region is determined in such a manner that a length of one side of a partial region is a power of two times a length of one side of a smallest voxel size.

8. The shape generation apparatus according to claim 1, wherein
a first voxel is divided into a plurality of second voxels smaller than the first voxel to define the plurality of second voxels as the plurality of voxels.

9. The shape generation apparatus according to claim 8, wherein
from among the plurality of voxels, a voxel determined to be a portion of the subject is deemed to be the first voxel and further subjected to division, and the plurality of second voxels obtained by the division are redefined as the plurality of voxels.

10. The shape generation apparatus according to claim 9, wherein
when the plurality of second voxels are defined, a size of a partial region corresponding to a size of the plurality of second voxels is determined, and
each time the plurality of second voxels are defined, the visible camera information is generated for a partial region of the determined size.

11. The shape generation apparatus according to claim 9, wherein
when the plurality of second voxels are defined, whether or not the visible camera information can be generated for a partial region of a size corresponding to the size of the plurality of second voxels is determined based on the memory amount, the information relating to the data size, and a total number of the second voxels.

12. The shape generation apparatus according to claim 11, wherein
in a case where it is determined that the visible camera information can be generated for a partial region of a size corresponding to the size of the plurality of second voxels, the visible camera information is generated for the partial region.

13. The shape generation apparatus according to claim 11, wherein
in a case where it is determined that the visible camera information cannot be generated for a partial region of a size corresponding to the size of the plurality of second voxels, whether each of the plurality of second voxels is a portion of the subject is determined using the visible camera information for a partial region corresponding to the first voxel or a voxel that includes the first voxel and is larger in size than the first voxel.

14. A control method executed by a shape generation apparatus that generates a shape model of a subject using captured images captured using a plurality of cameras, the control method comprising:
generating visible camera information indicating whether or not each of partial regions is visible from each of the plurality of cameras, the partial regions being obtained by dividing a shape generation region for which the shape model is to be generated;
defining a plurality of voxels in the shape generation region;
determining whether each voxel included in the plurality of voxels is a portion of the subject by not projecting the voxel onto a camera for which the partial region corresponding to the voxel is not visible according to the visible camera information and projecting the voxel onto a camera for which the partial region corresponding to the voxel is visible according to the visible camera information;
outputting the shape model of the subject based on a result of the determining; and
determining a size of a partial region based on a size of the shape generation region, a memory amount indicating an amount of memory available for holding the visible camera information, and information relating to a data size of data indicating whether one voxel is visible from each of the plurality of cameras.

15. A non-transitory computer-readable storage medium that stores a program for causing a computer included in a shape generation apparatus, which generates a shape model of a subject using captured images captured using a plurality of cameras, to execute a control method comprising:
generating visible camera information indicating whether or not each of partial regions is visible from each of the plurality of cameras, the partial regions being obtained by dividing a shape generation region for which the shape model is to be generated;
defining a plurality of voxels in the shape generation region;
determining whether each voxel included in the plurality of voxels is a portion of the subject by not projecting the voxel onto a camera for which the partial region corresponding to the voxel is not visible according to the visible camera information and projecting the voxel onto a camera for which the partial region corresponding to the voxel is visible according to the visible camera information;
outputting the shape model of the subject based on a result of the determining; and
determining a size of a partial region based on a size of the shape generation region, a memory amount indicating an amount of memory available for holding the visible camera information, and information relating to a data size of data indicating whether one voxel is visible from each of the plurality of cameras.
